(19) United States
(12) Patent Application Publication
(10) Pub. No.: US 2015/0203111 A1
(43) Pub. Date: Jul. 23, 2015

(54) Method for Carrying Out a Process of Parking a Vehicle by Means of a Driver Assistance System

(71) Applicant: Daimler AG, Stuttgart (DE)

(72) Inventors: Christophe Bonnet, Leinfelden-Echterdingen (DE); Andreas Hiller, Stuttgart (DE); Gerhard Kuenzel, Benningen (DE); Martin Moser, Fellbach (DE); Heiko Schiemenz, Stuttgart (DE)

(21) Appl. No.: 14/420,504

(22) PCT Filed: Aug. 3, 2013
(86) PCT No.: PCT/EP2013/002328

§ 371 Date: Feb. 9, 2015

(30) Foreign Application Priority Data
Aug. 10, 2012 (DE) 10 2012 015 922.6

(51) Int. Cl. B60W 30/06

(52) U.S. Cl. CPC B60W 30/06

(57) ABSTRACT

A method for performing an automatic parking process of a vehicle involves offering a user a selection between at least two parking maneuver for implementing by a driver assistance system in the vehicle. The first parking maneuver is a direct parking maneuver in which an automatic parking process is performed from the start position directly to the target position along the trajectory. The second parking maneuver involves providing a break point the parking trajectory so that a user can disembark the vehicle at the break point and prior to the target position.

### BACKGROUND AND SUMMARY OF THE INVENTION

Exemplary embodiments of the invention relate to method for carrying out a process of parking a vehicle by means of a driver assistance system. The method involves detecting objects in an environment of the vehicle and their respective relative positions with respect to the vehicle. A target position and a trajectory to the target position are then determined by considering the detection of the environment and relative position. Subsequently, the parking process along the determined trajectory is carried out by means of a control device, wherein the trajectory is adapted during the implementation of the parking process, considering the continuously detected environment objects.

The parking spaces and garages for vehicles are often designed to be small due to the limited parking situation in cities and car parks. If a vehicle is parked, for example, in a parking space between two stationary vehicles at the sides, the doors of the vehicle can often only be opened at a comparatively small angle and the vehicle user can only leave the parked vehicle with difficulty.

In the last few years, automatic and autonomous solutions have been developed to address this problem. Therein, the user of the vehicle can disembark in front of the parking space and can then initiate the autonomous parking procedure via radio. For this there are two solutions. In the first solution, the vehicle can only be moved straight forwards and straight backwards. In the second solution, the parking space and the surroundings of the vehicle are detected by means of suitable sensor devices. The vehicle can park autonomously in this detected parking space.

German patent document DE 102 06 763 A1 discloses a method to park a vehicle in which the obstacles in the environment of the vehicle are detected. Both the distances of the vehicle to the obstacles and the length or width of a parking space are determined. Sensors are used both for parking space determination and for distance measurement. In the case of falling below a predetermined distance to an obstacle, a warning signal is emitted to the driver.

European patent document EP 1 249 379 A2 discloses a method to bring a motor vehicle into a target position in which the motor vehicle is brought into a start position close the target position that is aimed for. After a first activation on the part of the driver, the surroundings of the motor vehicle are continuously scanned and the current vehicle position is continuously determined. A trajectory to the target position is determined by means of the determined surroundings and positional information. To drive the trajectory, control information is generated to bring the motor vehicle into the target position. After a second activation on the part of the driver, the control command that depends on the control information is emitted to the drive train, the brake system and the steering of the motor vehicle. Thus, the motor vehicle drives into the target position independently of the driver. The activation on the part of the driver can take place outside the motor vehicle.

German patent document DE 10 2009 041 587 A1 discloses a driver assistance device that includes a control device that emits control signals to a drive and steering device of the motor vehicle and initiates an implementation of an autonomous parking process. By means of a remote control, commands can be given to the control device from outside the vehicle. After receiving a predetermined interruption command, a parking process of the motor vehicle that has already begun can be interrupted. At least one camera is coupled to the control device and obtains image data over a surrounding region of the motor vehicle. The control device sends the image data obtained by the camera or image data calculated from this to the remote control. The remote control depicts this image data by means of complex display and operation units.

German patent document DE 10 2011 003 231 A1 discloses a method and a device to automatically carry out a driving maneuver with a motor vehicle. The method comprises the following steps: (a) detection of the surroundings of the motor vehicle with a first detection system whilst driving past a parking space, (b) calculation of a trajectory, along which the motor vehicle is moved during the driving maneuver, by means of the surroundings data detected in step (a), (c) automatic movement of the motor vehicle along the trajectory to carry out the driving maneuver, wherein the surroundings of the motor vehicle are detected with a second detection system that is different from the first whilst the motor vehicle is moved. The data detected by the first detection system is transferred to a portable control device. Using the portable control device, it is possible to monitor the driving maneuver even outside the vehicle. The driver can interrupt the driving maneuver, comfortably disembark and subsequently continue the driving maneuver from outside the vehicle. Here the interruption of the driving maneuver is controlled by the driver and not by the vehicle.

German patent document DE 10 2009 046 674 A1 discloses a method to support a process of parking a motor vehicle in a parking position by means of a parking device. The parking device has at least one sensor device, which sensor device is formed at least to detect the contours of the parking position, wherein the method has at least the following steps: driving into a region in front of at least one parking position with the motor vehicle and detection of the region by the sensor device, initiation of a driving reaction by the driver of the motor vehicle, which is formed in such a way that the intention of the driver of the motor vehicle to park the motor vehicle in a parking position is recognized by the parking device, recognition of the arrangement of the parking position by the sensor device relative to the motor vehicle, instant detection of the contours of the parking position by the sensor device and guiding of the motor vehicle to the parking position by the parking device. Here, a selection of different parking trajectories or arrangements within the parking position is offered to the user.

German patent document DE 10 2005 046 827 A1 discloses a method for parking support in which in the case of an at least partial positioning of the vehicle in a parking space, said positioning not yet having been completed, the dimensions of the parking space are determined and a trajectory of the vehicle to complete the parking process is determined. Here, different trajectories are offered to the driver for selection.

With the device and method that has been known until now, the user of the vehicle has the possibility to select different trajectories for the parking process, but no possibility for selection to carry out a determined parking maneuver. Additionally, the vehicle assistance system does not offer the driver the possibility to choose between parking processes with the driver in the vehicle and outside the vehicle.

Exemplary embodiments of the present invention are directed to optimizing a parking process such that it can be carried out particularly reliably and in a user friendly manner.

In accordance with the invention, at the beginning of the parking process a selection possibility between at least two parking maneuvers is made available to the user of the driver assistance system in the vehicle. The first parking maneuver is a direct parking maneuver; therein a parking process from the start position directly to the target position, known in prior art, is carried out. For the further parking maneuver, a break point is determined along the trajectory and this break point allows the user to disembark.

In comparison to the direct parking maneuver, in the further parking maneuver, not only is a trajectory to the target position determined, but also a break point along the trajectory. The vehicle is stopped at this break point. That is, when carrying out the parking process the vehicle does not drive automatically into the target position as in the direct parking maneuver, but stops at a suitable break point before the target position during driving of the trajectory. In order to determine this break point, both the fixed objects, such as, for example, a wall, and the moving objects, such as, for example, pedestrians, are continuously considered in the surroundings. Thus, a narrow parking space, a narrow garage or a parking space that is difficult to drive into, such as parking spaces next to a wall, a hedge or similar, where it is made difficult for a user to disembark, can be used.

Preferably, the break point for the disembarking of a user is determined such that the target position is reached in one stroke, so without change of driving direction, during the continuation of the parking process. This is referred to below as one-stroke parking.

In order to bring a vehicle into a target position along a determined trajectory, several changes in direction from forward drive and backward drive of the vehicle are often carried out during the parking process. This is referred to as parking with multiple-stroke maneuvering processes. If the user starts such a parking process, an exact monitoring of the entire parking process by the user is of great importance. Therein it must be considered that not all obstacles are recognized with a determined environment recognition device. For example, thin bars cannot be recognized with certainty by means of an ultrasound sensor. Additionally, the complete vehicle contour, such as, for example, outer mirrors or a loaded roof, must be monitored with certainty. Above all, in multi-stroke maneuvering processes, the user must always be informed in which direction the vehicle will drive in the next stroke. A complex operation and display concept is necessary for this. Provided the user is located outside the vehicle, he must change his position, if necessary, during a change of direction of the vehicle in order to see the region in front of or behind the vehicle.

This monitoring is significantly simplified if necessary changes in direction from forward and backward drive of the vehicle are carried out before the break point and are monitored by a user in the vehicle. The user can actively intervene at any time.

Preferably, the completion of the parking process is activated by a user of the vehicle after the break point. Here it would also be conceivable to offer another selection possibility between different parking maneuvers to the user of the vehicle assistance system.

Thus the user of the vehicle receives the possibility to check the current parking situation and continue the parking process by a renewed activation. This is advantageous because the desire of the user is considered in a particularly simple way.

Preferably, the completion of the parking process is initiated and carried outside the vehicle out after the break point. The continuation of the parking process after the break point can be initiated and ended by a user situated outside the vehicle.

A parking maneuver controlled from outside is particularly advantageous if a very narrow parking space is present in which the vehicle still fits, however a disembarking of a user would no longer be possible. Thus, narrow parking spaces can also be supported by the system. The customer use of a vehicle assistance system can thus be considerably increased. Additionally, a limited parking area, such as, for example, a car park, can be made better use of.

A further advantage of the activation of the continuation of the parking process from outside is that the user can comfortably disembark. The user can the parking process from outside without great monitoring effort, above all if the vehicle is driven into the target position in one stroke, without changing the driving direction. If the activation of the continuation of the parking process from outside is only enabled after the break point, i.e. only for one-stroke parking, simple operating devices can be used for this.

Preferably, in this method, the break point of the vehicle is determined for the disembarking of a user such that the vehicle doors can be opened without collision with the detected objects. Thus, a comfortable and safe disembarking of the user is possible.

Preferably, the trajectory and the break point for the disembarking of a user are determined and adapted such that a predetermined distance is maintained to the detected objects. For example, if these objects are further vehicles, then a predetermined distance is maintained. This distance to be maintained considers, for example, the case in which a vehicle door of the further vehicle is opened. The vehicle, which moves during the parking process or stands at the break point, may not collide with the open door. Overall, safety distances to objects along the trajectory during the parking process or the break process can be provided such that a collision-free implementation of the parking process is supported.

In one development of the method, the trajectory and the break point for the disembarking of a user are determined and adapted such that the seat occupation of the vehicle is considered.

Therein, for example, the positioning of the vehicle in a parking space or next to a lateral limit is adapted depending on a seat occupation of the vehicle. The lateral distances of the vehicle to objects, for example, other vehicles, which limit the parking space or break point laterally, can be selected such that the respective vehicle user can disembark from the vehicle without problem. If only a driver sits in the vehicle, a correspondingly shorter distance to an object limiting the parking space or the break point can be selected than on the passenger side. This enables an optimum use of a narrow parking space.

Preferably the completion of the parking process is initiated by the user after the break point, either by means of a mobile operating unit or by means of a voice control device or by means of a gesture recognition device.

Preferably if the enabling of the activation of the continuation of the parking process occurs from outside the vehicle only after the break point, i.e., only for single-stroke parking, a simple operating device can be used. This can, for example, be implemented by means of a simple mobile operating unit having two operating elements with which the forward and backward driving is activated separately. Likewise, the forward or the backward driving can be implemented simply by voice command or two different hand signals.

Finally it is preferable that the driving direction of the vehicle is displayed during the parking process by a lighting device on the vehicle. A light signal can be used in order to clarify the driving direction of the vehicle to the user situated outside the vehicle. For this purpose, for example, the front indicators can be controlled for the forward driving and the rear indicators for the backward driving.

Thus, a simple mobile operating device can be used. A complex display device that depicts the driving direction of the vehicle can be dispensed with. A user who is situated outside the vehicle can always direct his view to the vehicle and thus better monitor the parking process.

Preferably, the flashing frequency of the lighting device of the vehicle varies depending on the distance to the detected objects. The distance to the next recognized obstacle is communicated to the user via the flashing frequency. The shorter the distance, the faster the lights flash.

This enables a particularly simply depiction of the driving direction and the distance to the next detected object.

### BRIEF DESCRIPTION OF THE DRAWING FIGURES

There are now different possibilities to design and develop the teaching of the present invention in an advantageous way. For this purpose reference is made to the following explanation of the embodiment. One embodiment of the method according to the invention is depicted in the drawing. Herein are shown, in schematic depiction,

FIG. 1 top view onto a parking situation, wherein a vehicle is maneuvered backwards into a perpendicular parking space;

FIG. 2 top view onto a parking situation, wherein a vehicle is maneuvered forwards into a parallel parking space;

### DETAILED DESCRIPTION

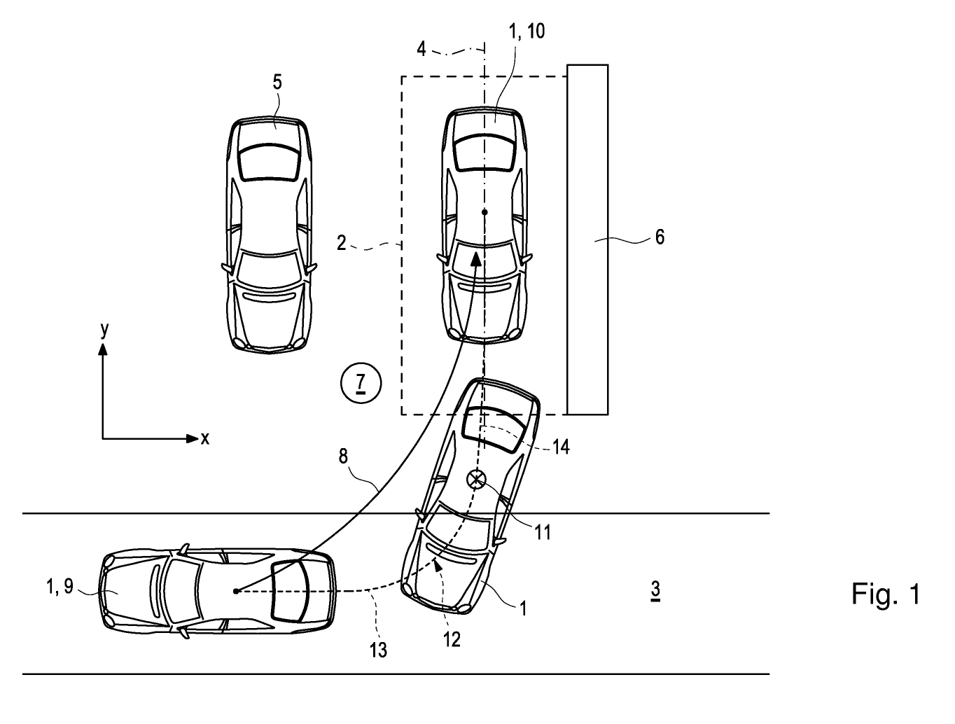

FIG. 1 shows a parking situation in a schematic depiction in which a vehicle 1 is maneuvered backwards into a parking space 2. The vehicle 1 is situated on a road 3 that is navigable in the x direction. The parking space 2 borders the road 3 in such a way that a longitudinal axis 4 of the parking space 2 runs in the y direction and thus perpendicularly to a longitudinal axis of the road 3. The parking space 2 is directly limited on each side, for example by a vehicle 5 and wall 6. An additional object, for example a post or a pedestrian 7, is situated to the side, in front of the parking space 2.

The parking space 2 is recognized while driving the vehicle 1 past the parking space 2. The objects 5, 6 and 7 in the environment of the vehicle 1 are detected. Subsequently, two parking maneuvers: “Direct Parking” or “Parking with Break Point” are determined by considering the environment and relative position detection and are offered to the user in the vehicle 1 for selection.

If the user in the vehicle selects the first parking maneuver “Direct Parking”, then a trajectory 8 for the parking process from the start position 9 to the target position 10 in the parking space 2 is determined. Subsequently an at least partially autonomous control of the vehicle 1 along the trajectory 8 occurs using a control device, wherein the trajectory 8 is adapted during the implementation of the parking maneuver by considering the continuously detected environment objects 5, 6 and 7.

If the user in the vehicle selects the second parking maneuver “Parking with Break Point”, then, in comparison to “Direct Parking”, a trajectory 12 is determined with a break point 11. The parking process is carried out from the start position 9 to the break point 11 and the vehicle 1 is stopped at the break point 11.

This break point 11 is always determined if the width of the parking space 2 is below a determined limit value, for example, smaller than the total width of the vehicle 1 including open side doors. Therein, the position of the break point 11 along the trajectory 12 must be determined such that the user of the vehicle 1 has enough space to comfortably and safely disembark.

Furthermore, the determination and adaptation of the break point 11 occurs such that all required changes in driving direction from forward driving and backward driving of the vehicle are carried out before the break point 11. After stopping at the break point 11, the vehicle 1 is then driven into the target position 10 in one stroke, without a change in driving direction. The trajectory 12 is divided into two partial trajectories 13, 14 by the break point 11. The first partial trajectory 13 comprises all required changes to the driving direction from forward driving and backward driving of the vehicle. The parking process is stated by a user inside the vehicle 1. The user remains sitting in the vehicle 1 and monitors the parking process while the vehicle 1 drives at least partially automatically from the start position 9 along the trajectory 13 to the break point 11. The completion of the parking process, which is initiated from outside the vehicle 1, is enabled from the break point 11.

If the user of the vehicle 1 disembarks at the break point 11, then the user has the possibility to check the current parking situation from the outside. The user can activate the completion of the parking process from outside the vehicle 1. Therein the user monitors the entire implementation and can, if necessary, interrupt the implementation at any time. The second partial trajectory 14 does not comprise any change of driving direction, i.e. only forward or backward driving. After the activation of the user, the vehicle 1 ends the parking process along the trajectory 14 and parks the vehicle 1 in the target position 10.

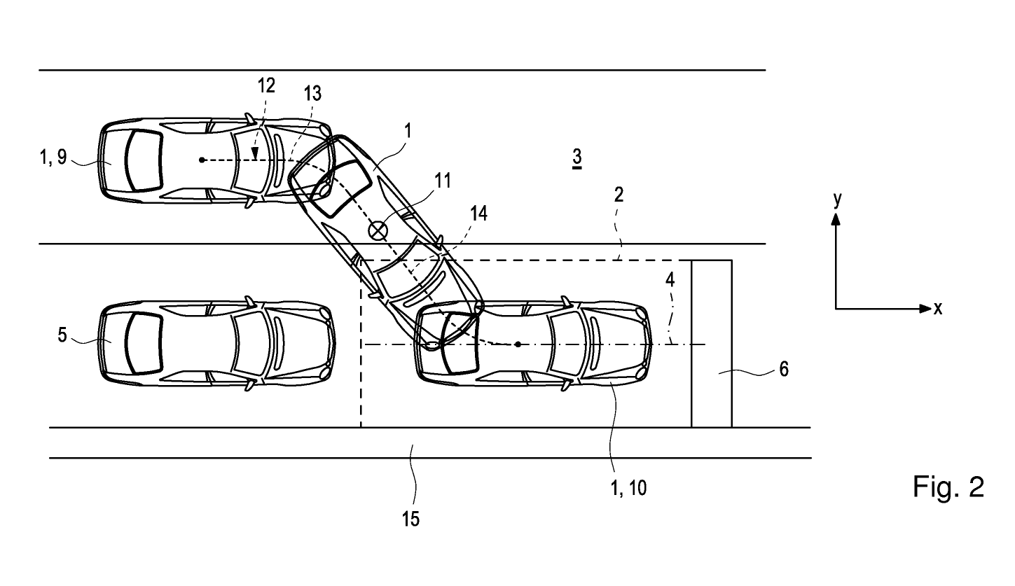

FIG. 2 shows a parking situation in a schematic depiction in which a vehicle 1 is maneuvered forwards into a parking space 2. The vehicle 1 is situated on a road 3 that is navigable in the x direction. The parking space 2 borders the road 3 in such a way that a longitudinal axis 4 of the parking space 2 runs in the x direction and thus is parallel to a longitudinal axis of the road 3. The parking space 2 is directly limited on each side by, for example, a vehicle 5 and walls 6 and 15.

If the second parking maneuver “Parking with a Break Point” is selected from the possible parking maneuvers, then a trajectory 12 is determined with a break point 11. The parking process is carried out from the start position 9 to the break point 11 and the vehicle 1 is stopped at the break point 11. Therein the parking space 2 can be driven into such that at the beginning of the parking process, no complete trajectory 12 to the target position is detected, but a short trajectory within the region that is able to be detected by environment detection, i.e., the vehicle advances.

The determination and adaptation of the trajectory 12 and of the break point 11 are determined such that the vehicle 1 is directed in parallel to a longitudinally-extended object, depicted here as a wall 15. At the same time, the position of the break point 11 is determined such that the user of the vehicle 1 has enough space to disembark comfortably and safely. Here, for example, the break point 11 can be determined such that the lateral distance of the vehicle to the vehicle 5 and to the wall 15 is larger than the total width of the vehicle 1 including open doors.

As in FIG. 1, the trajectory 12 comprises a break point and two partial trajectories 13, 14. The first partial trajectory 13 comprises all required changes in driving direction from forward driving and backward driving of the vehicle. The parking process is started by a user inside the vehicle 1. The passenger, for example, disembarks at the break point 11 and activates the completion of the parking process outside the vehicle 1. The driver remains sitting in the vehicle 1 and monitors the parking process, while the vehicle 1 drives along the partial trajectory 14 into the target position 10 in one stroke.

Furthermore, in the case of the determination and adaptation of the trajectory 12 and of the break point 11, the seat occupation of the vehicle 1 can be considered. The positioning of the vehicle 1 in a parking space 2 or at the break point 11 can be adapted depending on a seat occupation of the vehicle 1. As in the case shown in FIGS. 1 and 2, the passenger disembarks at the break point 11; therefore the partial trajectory is adapted such that less space is left on the passenger side to the object 6 or 15 than on the driver side. For a case in which the driver's seat is also not occupied, the vehicle 1 can be driven at a low minimum distance up to the corresponding objects such as, for example, 5 in FIG. 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A method for performing a parking process of a vehicle using a vehicle assistance system, the method comprising:
detecting, by vehicle sensors, objects in an environment of the vehicle;
determining a target position for the parking process based on the objects detected in the environment;
determining a trajectory from a start position of the vehicle to the target position;
performing the parking process along the determined trajectory by using a control device, wherein the trajectory is adapted during the parking process by considering continuously detected environment objects,
wherein at a beginning of the parking process the vehicle assistance system receives a selection from a user of either a direct parking maneuver or a further parking maneuver, and
wherein the further parking maneuver involves determining a break point along the trajectory, wherein the break point is provided to allow the user to disembark the vehicle and the target position is reached in one stroke in a continuation of the parking process from the break point.

11. The method of claim 10, wherein the continuation of the parking process to completion into the target position is activated by the user of the vehicle after the break point.

12. The method of claim 10, wherein the continuation of the parking process to completion into the target position is initiated and carried out outside the vehicle after the break point.

13. The method of claim 10, wherein the break point of the vehicle for the disembarking of a user is determined such that the vehicle doors are opened without collision at the break point.

14. The method of claim 10, wherein the trajectory and the break point for the disembarking of a user is determined and adapted such that a predetermined distance to the detected objects is maintained.

15. The method of claim 10, wherein the trajectory and the break point for the disembarking of the user is determined and adapted by considering seat occupation of the vehicle.

16. The method of claim 10, wherein the continuation of the parking process to completion into the target position is initiated by the user after the break point using a mobile operating unit, a voice control device, or a gesture recognition device.

17. The method of claim 10, wherein a driving direction of the vehicle is displayed by a lighting device on the vehicle during the parking process.

18. The method of claim 17, wherein a blinking frequency of the lighting device of the vehicle is controlled depending on a distance to the detected objects.
